(19) United States
(12) Patent Application Publication
(10) Pub. No.: US 2016/0072570 A1
(43) Pub. Date: Mar. 10, 2016

(54) WIRELESS COMMUNICATION DEVICE AND WIRELESS COMMUNICATION METHOD

(71) Applicant: FUJITSU LIMITED, Kawasaki-shi (JP)

(72) Inventors: Dai KIMURA, Yokohama (JP); Chimato KOIKE, Fujisawa (JP); Shunsuke FUJIO, Kawasaki (JP)

(21) Appl. No.: 14/808,633

(22) Filed: Jul. 24, 2015

(30) Foreign Application Priority Data
Sep. 8, 2014 (JP) 2014-182793

(51) Int. Cl. H04B 7/06; H04W 72/02; H04W 72/08; H04W 72/04

(52) U.S. Cl. CPC H04B 7/0697; H04W 72/046; H04W 72/02; H04B 7/0617; H04W 72/085

(57) ABSTRACT

A wireless communication device including: a plurality of phase shifters, each of the plurality of phase shifters adjusting each amplitude and each phase of each analog signal by each element of a transmission weight vector, each analog signal being generated by multiplexing a plurality of signals that are addressed to a plurality of terminals respectively, a plurality of antennas, each of the plurality of antennas transmitting each analog signal whose phase has been shifted by each of the plurality of phase shifter, and a processor configured to: obtain a plurality of steering vectors that correspond to the plurality of terminals respectively, and generate the transmission weight vector by combining the plurality of steering vectors.

### CROSS-REFERENCE TO RELATED APPLICATION

This application is based upon and claims the benefit of priority of the prior Japanese Patent Application No. 2014-182793, filed on Sep. 8, 2014, the entire contents of which are incorporated herein by reference.

### FIELD

The embodiments discussed herein relate to a wireless communication device and a wireless communication method.

### BACKGROUND

The number of wireless communication devices has been growing recently and thus the demand for improving resource utilization efficiency (e.g., frequency utilization efficiency) has been increasing dramatically while communication speeds have risen and bandwidths for communication has become wider.

One technique for improving resource utilization efficiency is called “beam forming”. For example, a base station that uses “beam forming” transmits an analog signal addressed to a terminal that is the transmission destination by multiplying the analog signal by a “transmission weight vector” to control the phase and amplitude of the analog signal. A radio wave can be concentrated on an area in which the terminal that is the transmission destination is located by adjusting the “transmission weight vector”. As a result, interference with the radio wave of another terminal can be reduced whereby the frequency utilization efficiency can be improved. In particular, wireless communication devices that perform communication in wide bandwidths and at high frequencies such as millimeter wave communication have small antenna elements. Furthermore, propagation loss of wireless signals at high frequencies is generally high. As a result, wireless communication devices that perform communication at high frequencies and in wide bandwidths typically use “beam forming” to compensate for propagation loss.

Another technique for improving resource utilization efficiency is called “multiplexing”. For example, a base station using “multiplexing” multiplexes signals addressed to a plurality of terminals which are transmission destinations into frequency regions digital and transmits the obtained multiplexed signals to the plurality of terminals which are transmission destinations. As a result, frequencies can be assigned efficiently to a plurality of terminals and consequently resource utilization efficiency is improved.

Japanese Laid-open Patent Publication No. 2003-264501 is an example of related art.

### SUMMARY

According to an aspect of the invention, a wireless communication device includes a plurality of phase shifters, each of the plurality of phase shifters adjusting each amplitude and each phase of each analog signal by each element of a transmission weight vector, each analog signal being generated by multiplexing a plurality of signals that are addressed to a plurality of terminals respectively, a plurality of antennas, each of the plurality of antennas transmitting each analog signal whose phase has been shifted by each of the plurality of phase shifter, and a processor configured to: obtain a plurality of steering vectors that correspond to the plurality of terminals respectively, and generate the transmission weight vector by combining the plurality of steering vectors.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example of a wireless communication system of a first embodiment;

FIG. 2 is a block diagram of an example of a first communication device of the first embodiment;

FIG. 3 is a view for explaining processing operations of the wireless communication system of the first embodiment;

FIG. 4 is a view for explaining transmission processing of reference signals by the first communication device in the first embodiment;

FIG. 5 is a view illustrating a gain obtained in response to a direction based on a front surface of the first communication device when each of a plurality of transmission weight vectors are used;

FIG. 6 is a view illustrating a gain obtained in response to a direction based on a front surface of the first communication device when each of a plurality of transmission weight vectors are used;

FIG. 7 is a block diagram illustrating an example of a wireless communication device according to another embodiment; and

FIG. 8 illustrates a hardware configuration example of the wireless communication device.

### DESCRIPTION OF EMBODIMENTS

However, while sufficient reception power can be obtained in a portion of a plurality of terminals subject to multiplexing when the conventional “beam forming” and “multiplexing” are simply combined, reception power for the rest of the terminals may deteriorate and receiving quality may decline.

In consideration of the above problem, it is an object of the technology disclosed herein to provide a wireless communication device and a calculation method that can improve reception quality.

The following will describe in detail aspects of the wireless communication device and the calculation method disclosed herein with reference to the drawings. The wireless communication device and the calculation method disclosed herein are not limited by the embodiments. Moreover, the same reference numerals are applied to configurations having the same functions in the embodiments and explanations thereof are omitted.

### First Embodiment

### Outline of Wireless Communication System

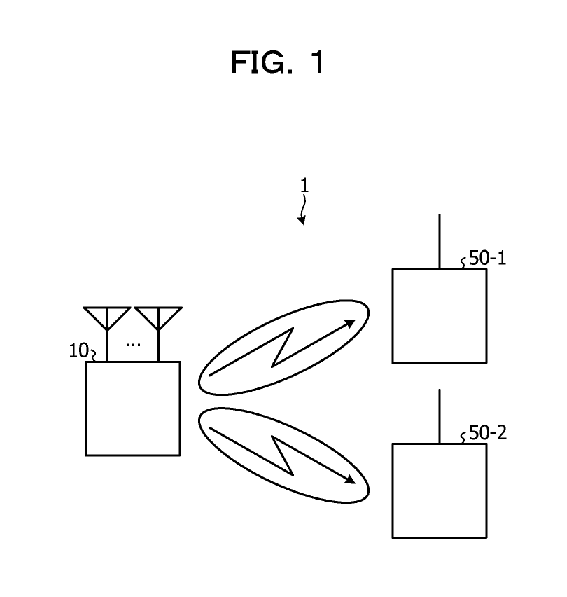

FIG. 1 is an example of a wireless communication system of a first embodiment. A wireless communication system 1 has a wireless communication device 10 and wireless communication devices 50-1 and 50-2 in FIG. 1. The wireless communication device 10 is for example a wireless base station and the wireless communication devices 50-1 and 50-2 are for example wireless terminals. If not differentiated in particular below, the wireless communication devices 50-1 and 50-2 may be referred to collectively as the wireless communication device 50. Further, the wireless communication device 10 may be referred to as a “first communication device” and the wireless communication device 50 may be referred to as a “second communication device” hereinbelow. The numbers of the wireless communication device 10 and the wireless communication device 50 are described as one and two, but the numbers thereof are not limited as such.

The wireless communication device 10 transmits an analog signal in which signals addressed to the wireless communication devices 50-1 and 50-2 are multiplexed, and multiplies the analog signal by a “transmission weight vector to be used” to control the phase and amplitude of the analog signal for each transmission antenna. That is, the wireless communication device 10 performs “analog beam forming”. The “transmission weight vector” is a vector comprising a weight for multiplying by the respective wireless transmitting units provided in the wireless communication device 10.

The wireless communication device 10 obtains respective “steering vectors” of the wireless communication devices 50-1 and 50-2. A “steering vector” is a vector composed of elements (i.e., weights) that represent only phase information in accordance with the direction of the wireless communication device 50 as seen from the wireless communication device 10. The following method may be used for example as a method for obtaining the “steering vector”. In a first method for obtaining the “steering vector”, the wireless communication device 10 sequentially switches the steering vectors and transmits “reference signals (i.e., known signals)” multiplied by the steering vectors. The wireless communication device 50 issues information pertaining to the steering vector (i.e., an “optimal steering vector”) having the largest reception power among the reference signals as feedback to the wireless communication device 10. The wireless communication device 10 then identifies the steering vector for the wireless communication device 50 based on the feedback information from the wireless communication device 50. A second method involves the wireless communication device 10 receiving reference signals transmitted from the wireless communication device 50 with the steering vectors switched sequentially. The wireless communication device 10 then identifies (estimates) the steering vector having the largest reception power (i.e., an “optimal steering vector”) among the reference signals.

The wireless communication device 10 then calculates a “transmission weight vector to be used” by combining the plurality of obtained steering vectors. Analog signals in which the signals addressed to the respective wireless communication devices 50-1 and 50-2 are multiplexed are multiplied by the calculated “transmission weight vector to be used”, and the analog signals are transmitted.

As a result, a beam pattern that can ensure reception power of the wireless communication devices 50-1 and 50-2 at the same time can be formed regardless of the positions of the wireless communication devices 50-1 and 50-2 and consequently reception quality can be improved.

### Configuration Example of First Communication Device

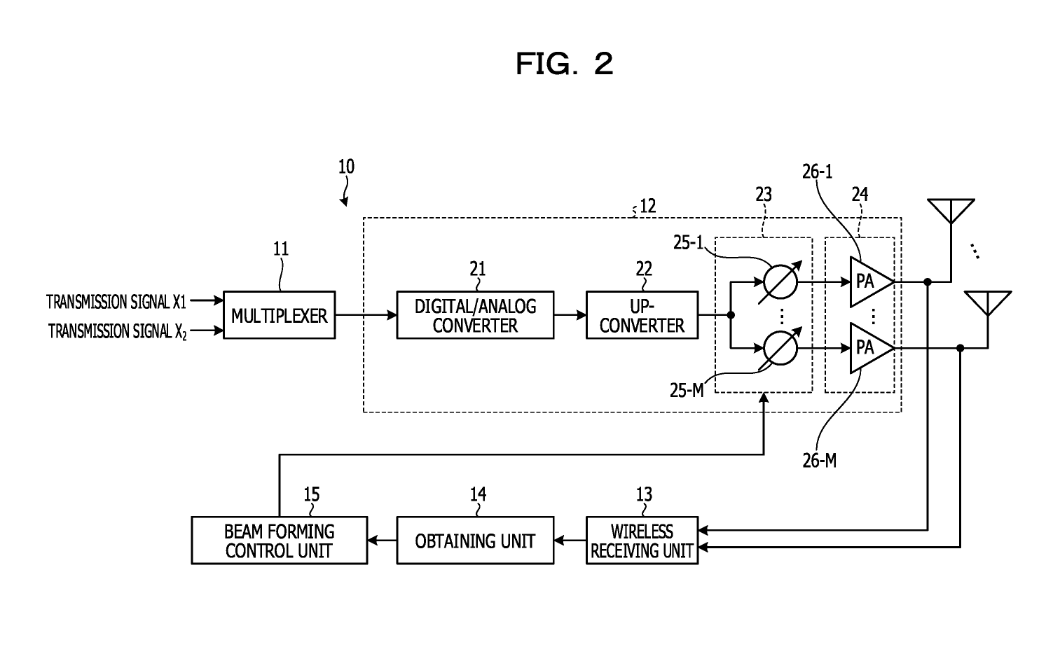

FIG. 2 is a block diagram of an example of a first communication device of the first embodiment. The wireless communication device 10 in FIG. 2 has a multiplexer 11, a wireless transmitting unit 12, a wireless receiving unit 13, an obtaining unit 14, and a beam forming control unit 15.

The multiplexer 11 inputs a transmission signal x₁ addressed to the wireless communication device 50-1 and a transmission signal x₂ addressed to the wireless communication device 50-2. The multiplexer 11 then multiplexes the inputted signals and outputs the obtained multiplexed signals to the wireless transmitting unit 12. The multiplexing method used by the multiplexer 11 in this case may be frequency multiplexing or code multiplexing for example.

The wireless transmitting unit 12 receives the multiplexed signals which are digital signals from the multiplexer 11. The wireless transmitting unit 12 then carries out digital-analog conversion on the multiplexed signals which are digital signals to obtain analog signals. The analog signals are composed of the multiplexed transmission signals x₁ addressed to the wireless communication device 50-1 and the transmission signals x₂ addressed to the wireless communication device 50-2. The wireless transmitting unit 12 multiplies the analog signals by the “transmission weight vector to be used” to control the phase and amplitude of the analog signals when transmitting the obtained analog signals.

For example, the wireless transmitting unit 12 has a digital/analog converter 21, an up-converter 22, a beam forming unit 23, and an amplifying unit 24 as illustrated in FIG. 2.

The digital/analog converter 21 carries out digital-analog conversion on the multiplexed signals received from the multiplexer 11 to obtain analog signals.

The up-converter 22 up-converts the analog signals obtained by the digital/analog converter 21 to obtain wireless signals.

The beam forming unit 23 receives the “transmission weight vector to be used” from the beam forming control unit 15. The beam forming unit 23 then multiplies the wireless signals (i.e., analog signals) obtained by the up-converter 22 by the “transmission weight vector to be used” received from the beam forming control unit 15, to obtain wireless signals in which the phase and the amplitude are controlled.

For example, the beam forming unit 23 has phase shifters 25-1 to 25-M (where M is a natural number of two or higher) as illustrated in FIG. 2. The phase shifters 25-1 to 25-M in FIG. 2 respectively correspond to different antennas. Moreover, the “transmission weight vector to be used” obtained from the beam forming control unit 15 includes M number of elements (i.e., transmission weights). The M number of elements respectively correspond to the phase shifters 25-1 to 25-M.

The wireless signals obtained by the up-converter 22 are inputted into the respective phase shifters 25-1 to 25-M. The phase shifters 25 multiply the inputted wireless signals by the transmission weights corresponding to the respective phase shifter 25 and output the obtained wireless signals to belowmentioned power amps 26 corresponding to the respective phase shifter 25.

The amplifying unit 24 amplifies the wireless signals obtained by the beam forming unit 23 and transmits the amplified wireless signals through the antennas.

For example, the amplifying unit 24 has the power amps (PA) 26-1 to 26-M as illustrated in FIG. 2. The power amps 26-1 to 26-M correspond to the respective phase shifters 25-1 to 25-M. The power amps 26 receive, from the corresponding phase shifters 25, the wireless signals in which the phase and amplitude thereof are controlled, amplifies the received wireless signals, and outputs the wireless signals to the corresponding antennas.

The wireless receiving unit 13 carries out wireless reception processing (e.g., down-converting, analog-digital converting) on the signals received through the antennas and outputs the obtained reception signals (i.e., digital signals) to the obtaining unit 14.

The obtaining unit 14 obtains respective “steering vectors” of the wireless communication devices 50-1 and 50-2. For example, if the method for obtaining the steering vector is the first method described above, the obtaining unit 14 extracts feedback signals (i.e., information pertaining to the optimal steering vector for each wireless communication device 50 ) of the respective wireless communication devices 50-1 and 50-2 from the reception signals received from the wireless receiving unit 13 and outputs the steering vectors corresponding to the extracted feedback signals to the beam forming control unit 15.

The beam forming control unit 15 calculates the “transmission weight vector to be used” by combining the “steering vectors” of the respective wireless communication devices 50-1 and 50-2 obtained by the obtaining unit 14. For example, the beam forming control unit 15 combines the “steering vectors” by using “weight coefficients to be used” to weight the plurality of steering vectors obtained by the obtaining unit 14. The “weight coefficient to be used” is a phase rotation amount, an amplitude change amount, or both a phase rotation amount and an amplitude change amount. In this case, the “weight coefficient to be used” is a weight coefficient that causes a norm value of the transmission weight vector to meet or exceed a predetermined level, such as a weight coefficient in which the norm value of the transmission weight vector is the greatest. A method for determining the “weight coefficient to be used” is explained in detail below.

### Operation Example of Wireless Communication System

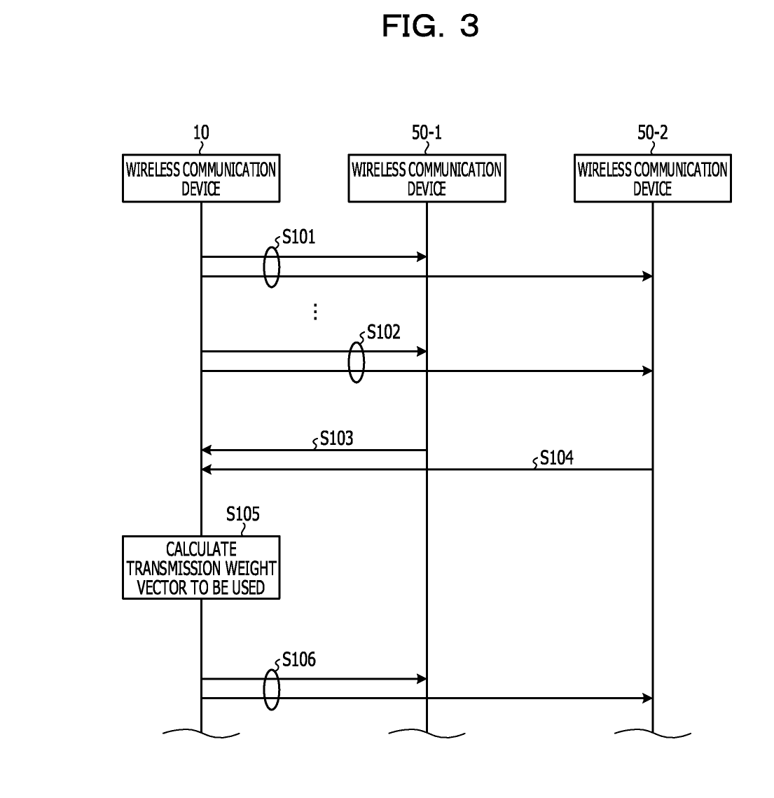

An example of processing operations in the wireless communication system 1 having the above configurations is described below. FIG. 3 is view for explaining processing operations of the wireless communication system of the first embodiment.

### Processing for Transmitting Reference Signals

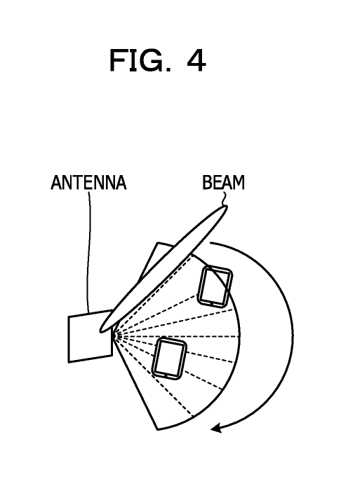

The wireless communication device 10 sequentially switches the steering vectors and transmits reference signals multiplied by the steering vectors (steps S101, S102). That is, as illustrated in FIG. 4, by sequentially switching the steering vectors, the direction of the beam is changed (i.e., turned) and the reference signals are transmitted sequentially. The transmission of the reference signals may be controlled by the beam forming control unit 15 or may be controlled by another control unit (not illustrated) provided in the wireless communication device 10. FIG. 4 is a view for explaining transmission processing of reference signals by the first communication device in the first embodiment.

### Processing for Identifying an Optimal Steering Vector

The wireless communication devices 50 sequentially receive the plurality of different reference signals multiplied by the steering vectors. The wireless communication devices 50 then identify the steering vectors multiplied by the received reference signals having the greatest reception power among the plurality of received reference signals.

### Feedback Processing of Optimal Steering Vector

The wireless communication device 50-1 and the wireless communication device 50-2 transmit information pertaining to the identified optimal steering vectors to the wireless communication device 10 (steps S103, S104).

### Processing for Calculating the Transmission Weight Vector to be Used

The beam forming control unit 15 in the wireless communication device 10 calculates the “transmission weight vector to be used” by combining the “steering vectors” of the respective wireless communication devices 50-1 and 50-2 obtained by the obtaining unit 14 (step S105). For example, the beam forming control unit 15 combines the plurality of steering vectors obtained by the obtaining unit 14 by weighting and adding plurality of steering vectors by using the “weight coefficients to be used”. In this case, the “weight coefficient to be used” is a weight coefficient that causes the norm value of the transmission weight vector to meet or exceed a predetermined level, such as a weight coefficient in which the norm value of the transmission weight vector is the greatest.

That is, when the respective optimal steering vectors of the wireless communication devices 50-1 and 50-2 are defined as ν₁ and ν₂, a transmission weight vector v is represented by the following equation (1).

ν=ν₁+αₒₚₜν₂ (1)

In equation (1), αₒₚₜ is a weight coefficient and is a complex scalar value.

The beam forming control unit 15 holds a plurality of weight coefficient candidates that satisfy |αₒₚₜ|=1. The beam forming control unit 15 then calculates a plurality of respective transmission weight vector candidates using equation (1) and the plurality of weight coefficient candidates. The beam forming control unit 15 then determines, as the weight coefficient to be used, a weight coefficient candidate corresponding to the transmission weight vector candidate having the greatest norm value among the calculated plurality of transmission weight vector candidates.

That is, the beam forming control unit 15 uses the following equation (2) for example to determine the weight coefficient to be used.

$${α}_{opt} = {argmax}_{α} ⌊ \sqrt{{( {v}_{1} + α {v}_{2} )}^{H} ( {v}_{1} + α {v}_{2} )} ⌋ \qquad ( 2 )$$

In equation (2), ν^{H} represents a complex conjugate transposition of ν.

When the weight coefficient to be used is determined, the beam forming control unit 15 uses equation (1) and the weight coefficient to be used to calculate the transmission weight vector, and then sets a transmission weight vector (referred to below as “standardized transmission weight vector”) ν_{FDM} in which the calculated transmission weight vector is standardized as the transmission weight vector to be used. That is, ν_{FDM} is represented by the following equation (3). A total transmission power can be constantly maintained due to the standardization of the transmission weight vector.

ν_{FDM}=ν/\sqrt{ν^{H}ν} (3)

While the beam forming control unit 15 is described above as determining, as the weight coefficient to be used, the weight coefficient candidate corresponding to the transmission weight vector candidate having the greatest norm value among the calculated plurality of transmission weight vector candidates calculated by using equation (1) and the respective plurality of weight coefficient candidates, the determination method is not limited as such. Thus, the weight coefficient αₒₚₜ to be used can be derived by directly solving equation (2), for example, through an analysis solution. The analysis solution αₒₚₜ of the weight coefficient to be used is derived using the following equation (4).

αₒₚₜ=exp(−j·arg(ν₁^{H}ν₂)) (4)

The problem expressed with the following equation (5) may be solved.

$${α}_{opt} = {{argmax}_{α} ( {v}_{1} + α {v}_{2} )}^{H} ( {v}_{1} + α {v}_{2} ) , s . t . \vert α \vert = 1 \qquad ( 5 )$$

A process for solving equation (5) is indicated below.

Because |αₒₚₜ|=1, αₒₚₜ=exp(jφ).

The gist of equation (5) can be put as “c” as illustrated in the following equation (6).

c=(ν₁+αν₂)^{H}(ν₁+αν₂) (6)

The right side of equation (6) is expanded to arrive at the following equation (7).

c=|ν₁|²+|ν₂|²+exp(jφ)ν₁^{H}ν₂+exp(−jφ)ν₂^{H}ν₁ (7)

When ν₁^{H}ν₂=a·exp(jθ) is put in equation (7), equation (7) can be expressed as in the following equation (8).

c=|ν₁|²+|ν₂|²+α·exp(j(φ+θ))+α·exp(−j(φ+θ))=|ν₁|²+|ν₂|²+2α·cos(φ+θ) (8)

Thus, when cos (φ+θ) is maximized, that is when φ=−θ+2π·n, “c” is maximized. However, “n” is an integer.

Thus, as illustrated in the following equation (9) when φ=−θ+2π·n is substituted for αₒₚₜ=exp(jφ), it can be seen that the above equation (4) is completed.

αₒₚₜ=exp(j(−θ+2π·n))=exp(−j·arg(ν₁^{H}ν₂)) (9)

While two users of the wireless communication devices 50-1 and 50-2 are assumed in the above explanation, the number of users is not limited to two. A generalized case in which N (where N is a natural number of 2 or higher) users are provided will be explained.

The transmission weight vector ν for N users is expressed in the following equation (10).

ν=Vαₒₚₜ (10)

However, αₒₚₜ is the vector of N×1 and is expressed in the following equation (11).

αₒₚₜ=[1,α_{opt.2}, α_{opt.3}, . . . α_{opt.N}]^{T} (11)

The V in equation (10) is a M×N matrix and is expressed by the following equation (12). Here, “M” is the number of antenna elements as described above.

V=[ν₁, ν₂, . . . , ν_{N}] (12)

The weight coefficient to be used is determined using the following equation (13).

$${α}_{opt} = {argmax}_{α} [ \sqrt{{( V α )}^{H} ( V α )} ] \qquad ( 13 )$$

(Data Transmission Processing)

The wireless communication device 10 multiplies the analog signals in which the transmission signal x₁ addressed to the wireless communication device 50-1 and the transmission signal x₂ addressed to the wireless communication device 50-2 are multiplexed, by the calculated transmission weight vector to be used, and then transmits the multiplied analog signals (step S106).

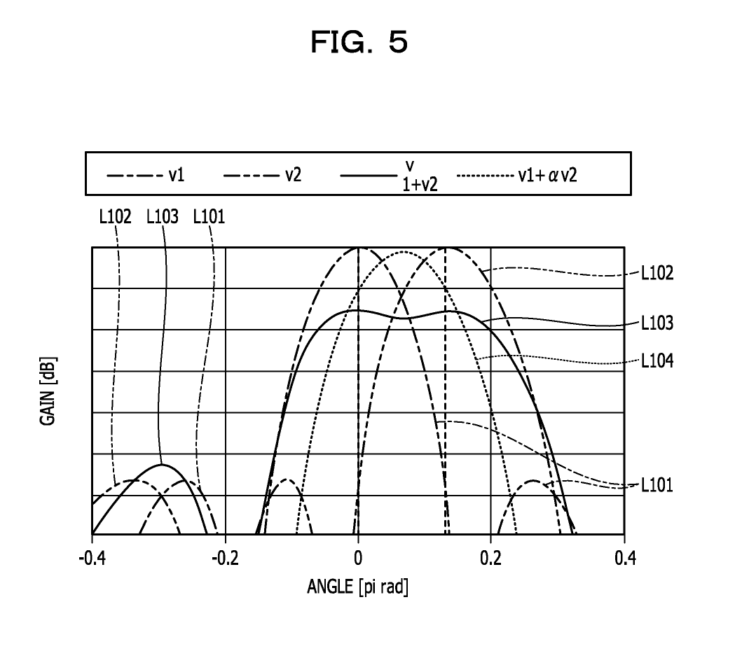

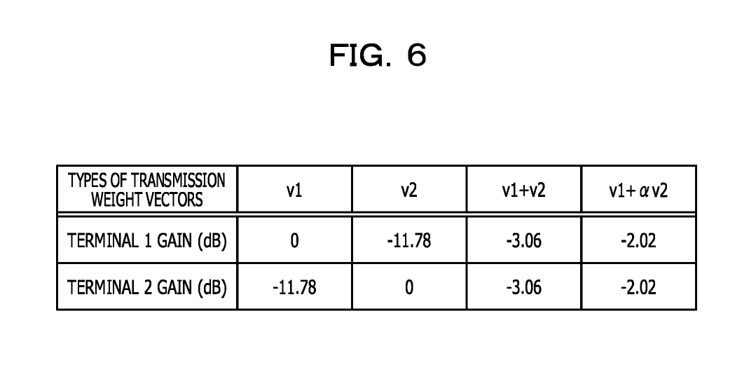

Herein follows an explanation of simulation results of the gains obtained in the respective wireless communication devices 50-1 and 50-2 when the respective plurality of transmission weight vectors are used. FIG. 5 and FIG. 6 are views illustrating gains obtained in response to a direction based on the front surface of the first communication device when each of a plurality of transmission weight vectors are used. FIG. 5 illustrates a curve L101 when the optimal steering vector ν₁ of the wireless communication device 50-1 is used, a curve L102 when the optimal steering vector ν₂ of the wireless communication device 50-2 is used, a curve L103 when the sum of the steering vectors ν₁ and ν₂ is used, and a curve L104 when the transmission weight vector calculated in accordance with the flow in FIG. 3 is used.

In this case, the wireless communication device 10 is assumed to have four antennas, and the four antennas are assumed to be arranged in a straight line separated only by 0.5λ (wavelengths). The wireless communication devices 50-1 and 50-2 are assumed to be arranged in directions 0 (rad) and 0.13 (rad) from the front surface of the antennas of the wireless communication device 10.

The respective values (gains) of the curves in FIG. 5 in the directions in which the wireless communication devices 50-1 and 50-2 are arranged are summarized in FIG. 6. The wireless communication device 50-1 is represented as terminal 1 and the wireless communication device 50-2 is represented as terminal 2 in FIG. 6. It can be seen that the low gain of the terminals can be improved by 8.72 dB by simply adding the steering vectors, and the gain can be further improved by 1 dB by optimizing the weight coefficient α.

According to the above present embodiment, the wireless communication device 10 transmits an analog signal in which signals addressed to the wireless communication devices 50-1 and 50-2 are multiplexed, and multiplies the analog signal by the “transmission weight vector to be used” to control the phase and amplitude of the analog signal for each transmission antenna. The beam forming control unit 15 in the wireless communication device 10 then calculates the “transmission weight vector to be used” by combining the plurality of obtained steering vectors for the plurality of wireless communication devices 50.

As a result of the configuration of the wireless communication device 10, a beam pattern that can ensure the reception powers of the wireless communication devices 50 at the same time can be formed regardless of the positions of the wireless communication devices 50 and consequently reception quality can be improved. That is, multiplex communication is made possible with beam patterns in which beam forming gains are obtained for the wireless communication devices 50.

The beam forming control unit 15 combines the plurality of steering vectors obtained for the respective wireless communication devices 50 by using “weight coefficients to be used” to add and weight the plurality of steering vectors. The “weight coefficient to be used” is set to a predetermined level, for example, the maximum of the norm value of the transmission weight vector.

As a result of the configuration of the wireless communication device 10, a beam pattern that can ensure sufficiently large reception powers of the wireless communication devices 50 at the same time can be formed. Consequently, the reception quality can be further improved.

### Second Embodiment

A second embodiment relates to a variation of the method for determining (method for calculating) the “weight coefficient to be used”. The main configurations of the wireless communication system, the first communication device, and the second communication device in the second embodiment are respectively the same as the wireless communication system, the first communication device, and the second communication device in the first embodiment and explanations thereof can be seen by referring to FIGS. 1 and 2.

The beam forming control unit 15 of the wireless communication device 10 according to the second embodiment calculates a plurality of transmission weight vector candidates using the plurality of respective weight coefficient candidates. The beam forming control unit 15 then calculates a “predicted throughput” of the wireless communication devices 50 when each of the calculated plurality of transmission weight vector candidates are used. The beam forming control unit 15 then determines the “weight coefficient to be used” from the plurality of weight coefficient candidates based on the calculated “predicted throughputs” of the wireless communication devices 50.

For example, the beam forming control unit 15 calculates a total value of the “predicted throughputs” of the wireless communication devices 50 from the transmission weight vector candidates and determines a weight coefficient candidate corresponding to the transmission weight vector having the largest calculated total value as the “weight coefficient to be used”.

That is, when a channel matrix between the wireless communication device 10 and the wireless communication device 50-1 is set as h₁, a predicted signal-to-noise ratio (SNR) γ₁ of the wireless communication device 50-1 is expressed by the following equation (14).

$${γ}_{1} = \frac{{v}^{H} {h}_{1}}{{σ}_{1}^{2}} \qquad ( 14 )$$

The σ₁² in equation (14) represents a noise electrical power of the wireless communication device 50-1. The noise electrical power can be inferred from the feedback signal from the wireless communication device 50-1.

Similarly, a predicted SNR γ₂ of the wireless communication device 50-2 is expressed by the following equation (15).

$${γ}_{2} = \frac{{v}^{H} {h}_{2}}{{σ}_{2}^{2}} \qquad ( 15 )$$

At this time, the predicted throughput T₁ of the wireless communication device 50-1 and the predicted throughput T₂ of the wireless communication device 50-2 can be expressed as in the following equation (16) by using Shannon's theorem.

T₁=B₁log₂(1+γ₁), T₂=B₂log₂(1+γ₂) (16)

B₁ and B₂ in this case are bandwidths respectively assigned to the wireless communication device 50-1 and the wireless communication device 50-2.

As illustrated in the following equation (17), L number of weight coefficient candidates α are prepared.

α₁=c^{j2πlL}(l=0.1, . . . L−1) (17)

The predicted throughputs of the wireless communication devices 50-1 and 50-2 for the weight coefficient candidates are expressed respectively as T₁(I) and T₂(I), and the total Tₛᵤₘ(I) of the predicted throughput of the wireless communication devices 50-1 and the predicted throughput of the wireless communication devices 50-2 is expressed by the following equation (18).

Tₛᵤₘ(l)=T₁(l)+T₂(l) (18)

The total throughput Tₛᵤₘ(I) for each of the L number of weight coefficient candidates is calculated and the weight coefficient candidate αₗ corresponding to the largest Tₛᵤₘ(I) is set as the weight coefficient to be used.

The following equation (19) may be used in place of equation (18).

Tₛᵤₘ(l)=log{T₁(l)}+log{T₂(l)} (19)

That is, the beam forming control unit 15 calculates the total value of the logarithmic values of the calculated predicted throughputs of the wireless communication devices 50 with regard to the transmission weight vector candidates and determines the weight coefficient candidate corresponding to the transmission weight vector having the largest calculated total value as the weight coefficient to be used.

According to the present embodiment as described above, the beam forming control unit 15 in the wireless communication device 10 calculates a plurality of transmission weight vector candidates using the respective weight coefficient candidates, and calculates the predicted throughputs of the wireless communication devices 50 when using the respective calculated transmission weight vector candidates. The beam forming control unit 15 then determines the weight coefficient to be used from the plurality of weight coefficient candidates based on the calculated predicted throughputs of the wireless communication devices 50.

For example, the beam forming control unit 15 may calculate the total value of the calculated predicted throughputs of the wireless communication devices 50 for the transmission weight vector candidates and may determine the weight coefficient candidate corresponding to the transmission weight vector having the largest calculated total value as the weight coefficient to be used. Alternatively, the beam forming control unit 15 may calculate the total value of the logarithmic values of the calculated predicted throughputs of the wireless communication devices 50 for the transmission weight vector candidates and may determine the weight coefficient candidate corresponding to the transmission weight vector having the largest calculated total value as the weight coefficient to be used.

As a result of the configuration of the wireless communication device 10, a beam pattern that can ensure sufficiently large reception powers of the wireless communication devices 50 at the same time can be formed. Consequently, the reception quality can be further improved.

### Other Embodiments

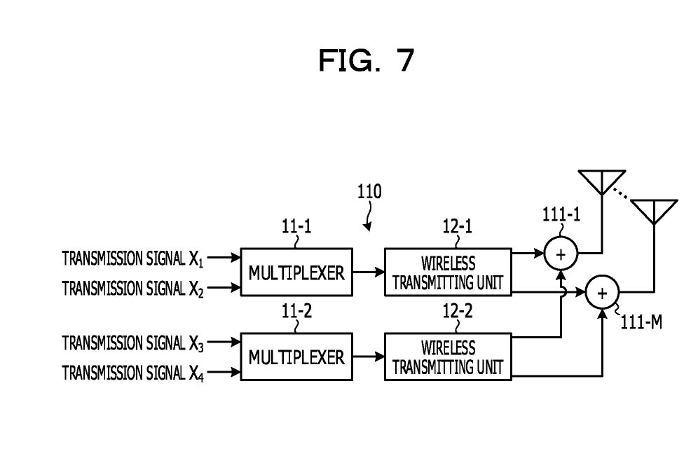

(1) While an example in which the wireless communication device 10 has one transmission system (i.e., the multiplexer 11 and the wireless transmitting unit 12) in the first and second embodiments, the number of transmission systems is not limited to one. For example as illustrated in FIG. 7, a wireless communication device 110 may have a first transmission system (a multiplexer 11-1 and a wireless transmitting unit 12-1) and a second transmission system (a multiplexer 11-2 and a wireless transmitting unit 12-2). Adding units 111-1 to 111-M are respectively provided in front of the antennas in the wireless communication device 110, and the adding units 111 output the wireless signals outputted by the respective wireless communication units 12-1 and 12-2 to the corresponding antennas. FIG. 7 is a block diagram illustrating an example of a wireless communication device according to another embodiment.

(2) While digital beam forming has not been described in the first and second embodiments, the configuration of the wireless communication device 10 described in the first and second embodiments may be provided with a digital beam forming unit. That is, analog beam forming and digital beam forming may be used in a hybrid manner. If the wireless communication device 10 uses digital beam forming, the digital beam forming unit is provided between the multiplexer 11 and the wireless transmitting unit 12.

(3) The constituent elements of the illustrated parts in the first and second embodiments do not have to be configured physically as illustrated. In other words, the embodiments are not limited to the particular forms of distribution and integration of each part and all or some of the parts may be configured to be functionally or physically distributed or integrated in arbitrary units according to the type of load or usage conditions and the like.

Furthermore, various processing functions conducted by the devices may be executed in part or in total on a central processing unit (CPU) (or a micro-computer such as a micro-processing unit (MPU) or a micro-controller unit (MCU)) and the like. Moreover, various processing functions may also be conducted in part or in total on a program that conducts analysis with the CPU (or a micro-computer such as an MPU or MCU), or on hardware based on wired logic.

The wireless communication devices of the first and second embodiments may be realized for example with the following hardware configuration.

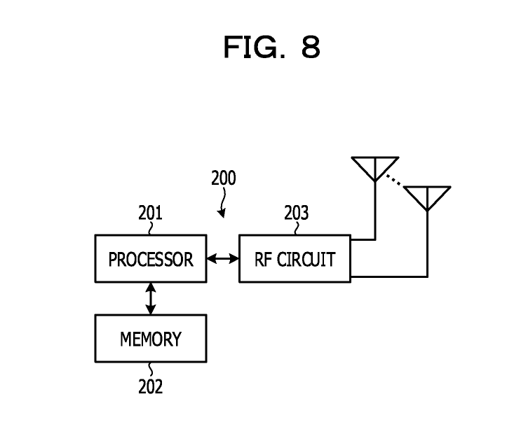

FIG. 8 illustrates a hardware configuration example of a wireless communication device. As illustrated in FIG. 8, a wireless communication device 200 has a processor 201, a memory 202, and a RF circuit 203. The wireless communication devices 10 and 50 in the first and second embodiments have the hardware configuration depicted in FIG. 8. A CPU, a digital signal processor (DSP), or a field programmable gate array (FPGA) may be considered as examples of the processor 201. A synchronous dynamic random access memory (SDRAM), a random access memory (RAM), a read-only memory (ROM), or a flash memory may be considered as examples of the memory 202.

The various processing functions conducted by the wireless communication devices in the first and second embodiments may be realized by the processor executing programs stored in various types of memories such as a non-volatile storage medium. Programs corresponding to the processing executed by the multiplexer 11, the obtaining unit 14, and the beam forming control unit 15 may be recorded in the memory 202 and the programs may be executed by the processor 201. The wireless transmitting unit 12 and the wireless receiving unit 13 are realized by the RF circuit 203.

While the various types of processing performed in the wireless communication devices of the first and second embodiments are described as being executed with one processor 201, the embodiments are not limited as such and the various types of processing may be performed with a plurality of processors.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication device comprising:
a plurality of phase shifters, each of the plurality of phase shifters adjusting each amplitude and each phase of each analog signal by each element of a transmission weight vector, each analog signal being generated by multiplexing a plurality of signals that are addressed to a plurality of terminals respectively;
a plurality of antennas, each of the plurality of antennas transmitting each analog signal whose phase has been shifted by each of the plurality of phase shifter; and
a processor configured to:
obtain a plurality of steering vectors that correspond to the plurality of terminals respectively, and
generate the transmission weight vector by combining the plurality of steering vectors.

2. The wireless communication device according to claim 1, wherein
the transmission weight vector is a weighted sum of the plurality of steering vectors, the weighted sum being calculated using at least one weight coefficient.

3. The wireless communication device according to claim 2, wherein
each of the at least one weight coefficient shifts each phase of each of at least part of the plurality of steering vectors.

4. The wireless communication device according to claim 2, wherein
the processor is configure to determine the at least one weight coefficient so that a norm of the transmission weight vector reaches a specified level.

5. The wireless communication device according to claim 2, wherein
the processor is configure to:
determine a plurality of vector candidates based on a plurality of coefficient set candidates respectively, each of the plurality of vector candidates being a candidate for the transmission weight vector, each of the plurality of coefficient set candidates being a candidate for the at least one weight coefficient,
estimate a plurality of throughput sets based on the plurality of vector candidates respectively, each of the plurality of throughput sets including a plurality of throughput of the plurality of terminals in case where each of the plurality of vector candidates is used, and
select a specified coefficient set candidate to be the at least one weight coefficient from the plurality of coefficient set candidates, based on the plurality of throughput sets.

6. The wireless communication device according to claim 5, wherein
the processor is configure to:
calculate a plurality of total throughputs based on the plurality of throughput sets respectively, each of the plurality of total throughputs being a total of a plurality of throughputs included in each of the plurality of throughput sets, and
select the specified coefficient set candidate to be the at least one weight coefficient, the specified coefficient set candidate corresponding a specifies total throughput that is the largest of the plurality of total throughputs.

7. The wireless communication device according to claim 5, wherein
the processor is configure to:
calculate a plurality of total logarithm throughputs based on the plurality of throughput sets respectively, each of the plurality of total logarithm throughputs being a total of a plurality of logarithms of the plurality of throughputs included in each of the plurality of throughput sets, and
select the specified coefficient set candidate to be the at least one weight coefficient, the specified coefficient set candidate corresponding a specifies total throughput that is the largest of the plurality of total logarithm throughputs.

8. A wireless communication method comprising:
adjusting each amplitude and each phase of each analog signal by each element of a transmission weight vector, each analog signal being generated by multiplexing a plurality of signals that are addressed to a plurality of terminals respectively;
transmitting each analog signal whose phase has been shifted;
obtaining a plurality of steering vectors that correspond to the plurality of terminals respectively; and
generating the transmission weight vector by combining the plurality of steering vectors.

9. The wireless communication method according to claim 8, wherein
the transmission weight vector is a weighted sum of the plurality of steering vectors, the weighted sum being calculated using at least one weight coefficient.

10. The wireless communication method according to claim 9, wherein
each of the at least one weight coefficient shifts each phase of each of at least part of the plurality of steering vectors.

11. The wireless communication method according to claim 9, further comprising:
determining the at least one weight coefficient so that a norm of the transmission weight vector reaches a specified level.

12. The wireless communication method according to claim 9, further comprising:
determining a plurality of vector candidates based on a plurality of coefficient set candidates respectively, each of the plurality of vector candidates being a candidate for the transmission weight vector, each of the plurality of coefficient set candidates being a candidate for the at least one weight coefficient;
estimating a plurality of throughput sets based on the plurality of vector candidates respectively, each of the plurality of throughput sets including a plurality of throughput of the plurality of terminals in case where each of the plurality of vector candidates is used; and
selecting a specified coefficient set candidate to be the at least one weight coefficient from the plurality of coefficient set candidates, based on the plurality of throughput sets.

13. The wireless communication method according to claim 12, wherein
the selecting of the specified coefficient set candidate includes:
calculating a plurality of total throughputs based on the plurality of throughput sets respectively, each of the plurality of total throughputs being a total of a plurality of throughputs included in each of the plurality of throughput sets, and
selecting the specified coefficient set candidate to be the at least one weight coefficient, the specified coefficient set candidate corresponding a specifies total throughput that is the largest of the plurality of total throughputs.

14. The wireless communication method according to claim 12, wherein
the selecting of the specified coefficient set candidate includes:
calculating a plurality of total logarithm throughputs based on the plurality of throughput sets respectively, each of the plurality of total logarithm throughputs being a total of a plurality of logarithms of the plurality of throughputs included in each of the plurality of throughput sets, and
selecting the specified coefficient set candidate to be the at least one weight coefficient, the specified coefficient set candidate corresponding a specifies total throughput that is the largest of the plurality of total logarithm throughputs.
